(19) United States
(12) Patent Application Publication
(10) Pub. No.: US 2024/0380361 A1
(43) Pub. Date: Nov. 14, 2024

(54) SOILING MITIGATION FOR SOLAR PANELS

(71) Applicant: DUKE ENERGY CORPORATION, Charlotte, NC (US)

(72) Inventors: Matthew Wiseman, Charlotte, NC (US); Fred Frost, Charlotte, NC (US); Art Villa, Santa Rosa, CA (US)

(21) Appl. No.: 18/659,072

(22) Filed: May 9, 2024

Related U.S. Application Data
(60) Provisional application No. 63/501,765, filed on May 12, 2023.

(51) Int. Cl. H02S 40/10; G06Q 10/04; H02S 50/00

(52) U.S. Cl. CPC H02S 40/10; G06Q 10/04; H02S 50/00

(57) ABSTRACT

Methods for solar-panel-soiling mitigation are provided. A method for solar-panel-soiling mitigation includes displaying, via a graphical user interface (GUI) on an electronic device, a predicted amount of photovoltaic (PV) output that will be lost due to soiling of solar panels that share a site. Moreover, the method includes displaying, via the GUI, a recommended date for cleaning the solar panels. The recommended date is an earliest calendar date on which a cost of cleaning the solar panels is less than or equal to a cost of the predicted amount of PV output that will be lost due to soiling.

### RELATED APPLICATIONS

The present application claims the benefit of U.S. Provisional Patent Application Ser. No. 63/501,765, filed on May 12, 2023, entitled SYSTEMS AND METHODS FOR FORECASTING OPTIMUM CLEANING DATES FOR SOLAR PANELS, the disclosure of which is hereby incorporated herein in its entirety by reference.

### FIELD OF THE INVENTION

The present invention relates generally to solar panels and, more particularly, to solar-panel cleaning.

### BACKGROUND OF THE INVENTION

Solar panels use energy from the sun and convert the sun's energy to electrical power. A common problem at solar sites is the accumulation of pollen, dust, and dirt on the solar panels that block irradiance from the sun. Thus, to maximize output, solar panels typically require periodic cleaning.

### SUMMARY OF THE INVENTION

It should be appreciated that this Summary is provided to introduce a selection of concepts in a simplified form, the concepts being further described below in the Detailed

Description This Summary is not intended to identify key features or essential features of this disclosure, nor is it intended to limit the scope of the invention.

Embodiments of the present invention provide a solar-panel-cleaning forecast tool that is configured to forecast how much output each solar site will lose due to contamination (e.g., from dust, dirt, etc., on the solar panels) and recommend the next profitable cleaning date. Embodiments of the present invention also allow solar site managers to simulate future cleaning dates and assess their profitability. Advantages of the present invention include allowing solar site managers to make quicker and more accurate cleaning decisions.

A method for solar-panel-soiling mitigation, according to some embodiments, may include displaying, via a graphical user interface on an electronic device, a predicted amount of photovoltaic output that will be lost due to soiling of solar panels that share a site. Moreover, the method may include displaying, via the graphical user interface, a recommended date for cleaning the solar panels. The recommended date may be an earliest calendar date on which a cost of cleaning the solar panels is less than or equal to a cost of the predicted amount of photovoltaic output that will be lost due to soiling.

A method for solar-panel-soiling mitigation, according to some embodiments, may include displaying, via a graphical user interface on an electronic device, an estimated amount of photovoltaic output that will be lost, due to soiling of solar panels that share a site, if the solar panels are not cleaned. The method may include displaying, via the graphical user interface, a recommended date for cleaning the solar panels. The recommended date may be an earliest calendar date on which a cost of cleaning the solar panels is less than or equal to a cost of the estimated amount of photovoltaic output that will be lost if the solar panels are not cleaned. The earliest calendar date may be determined based on a soiling loss for the solar panels that will be avoided over a multi-month future time period, starting on the recommended date, if the solar panels are cleaned on the recommended date. The method may include displaying, via the graphical user interface, the soiling loss for the solar panels that will be avoided over the multi-month period. Moreover, the method may include displaying, via the graphical user interface, a post-cleaning soiling-loss forecast over the multi-month period.

A method for solar-panel-soiling mitigation, according to some embodiments, may include receiving, from solar panels that share a site, photovoltaic output data, in kilowatt-hours, for the solar panels. The method may include determining, based on the photovoltaic output data and based on weather data, an amount of future photovoltaic output that will be lost due to soiling of the solar panels. The method may include determining an earliest calendar date on which a cost of cleaning the solar panels is less than or equal to a cost of the amount of future photovoltaic output that will be lost due to soiling. Moreover, the method may include transmitting, to an electronic device comprising a graphical user interface, computer-readable program code comprising the earliest calendar date.

It is noted that aspects of the invention described with respect to one embodiment may be incorporated in a different embodiment though not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim though not originally claimed in that manner. These and other objects and/or aspects of the present invention are explained in detail below.

### BRIEF DESCRIPTION OF THE DRAWINGS

The accompanying drawings, which form a part of the specification, illustrate various embodiments of the present invention. The drawings and description together serve to fully explain embodiments of the present invention.

FIGS. 1-3 are user interfaces displayed on a user device by a software tool according to some embodiments of the present invention.

FIG. 4 is a table that illustrates forecast rainfall data and forecast soiling-loss data for each day in a future time period, as determined in accordance with embodiments of the present invention.

FIGS. 5A-5C are tables illustrating soiling loss calculated for each day in the future time period in accordance with embodiments of the present invention.

FIG. 6 is a table that illustrates loss avoidance in kilowatt-hours (kWh) converted to dollars for each of the days in the future time period.

FIG. 7 illustrates an example processor and memory that may be used to forecast how much output a solar-panel site will lose due to soiling loss and to recommend the next profitable cleaning date, according to some embodiments of the present invention.

FIG. 8 is a schematic illustration of a grid and a microgrid, according to embodiments of the present invention.

FIG. 9 is a flowchart showing operations for mitigating soiling of the solar panels of FIG. 8.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein.

To optimize solar-panel performance while minimizing costs associated with cleaning, including lost revenue, it is desirable to be able to determine when and how often solar-panel cleaning should occur. Unfortunately, conventional methods of determining when and how often solar-panel cleaning should occur are disadvantaged because of the number of variables involved. For example, though rain may help wash away solar-panel contamination, predicting when and how much rain will fall at a particular solar site can be unreliable. Moreover, seasonal variables, such as pollen accumulation, may vary by geography and time of the year.

Solar-panel soiling is caused by the deposition of airborne particles, including, but not limited to, dirt, mineral dust (silica, metal oxides, salts), pollen, and soot. However, soiling also includes snow, ice, frost, various kinds of industry pollution, sulfuric acid particulates, bird droppings, falling leaves, agricultural feed dust, and the growth of algae, moss, fungi, lichen, or biofilms of bacteria. These soiling mechanisms may vary in prominence depending on location.

According to embodiments of the present invention, a software tool is provided that forecasts the amount of photovoltaic (PV) output for solar panels at a site that will be lost due to soiling using a Monte Carlo simulation based on historical precipitation data, PV production data, and solar-panel soiling-rate data. The software tool then determines the earliest date at which the cost of cleaning the solar panels is equal to (or less than) the median soiling loss recoverable over a ninety (90) day period. Using the results, an automatic system can be activated to perform a task, such as generating a work order for cleaning the solar panels and forwarding the work order to a person or entity that will perform the cleaning. Other tasks may include forwarding a notification to a third party that cleaning of the solar panels should occur, adding the cleaning date to a work schedule, etc.

The term “soiling loss”, as used herein, can be defined as either the energy that is expected to be produced but is not as a result of solar-panel soiling, or the amount of money lost based on a power purchase agreement between an electric utility and a customer. For example, for a given day, if a solar panel's output is only 98% of its potential output, the soiling loss is 2% for that day. The term “soiling rate”, as used herein, is the amount of PV output loss due to contamination (e.g., dirt/dust/pollen) and/or other material that has built up on a solar panel.

The software tool uses Monte Carlo simulations to predict the median amount of a solar-panel-site output lost due to soiling and recommends a cleaning date that is unique for each site. The term “Monte Carlo simulation”, as used herein, refers to modeling the probability of different outcomes in a process that cannot easily be predicted due to the intervention of random variables. Prior to the present invention, solar-panel-site managers scheduled cleanings manually without formalized structure or consideration of future soiling or weather, and these cleanings may not have been optimal economically.

According to embodiments of the present invention, the following is a summary of steps that can be performed to forecast an optimum future date to clean a solar panel or group of solar panels:
1. Determine current soiling-loss amount for a solar panel/group of solar panels.
2. Use historical production to produce a daily estimate of expected production from the solar panel/group of solar panels.
3. Walk through the first day in the forecast period using the soiling rate and expected production to estimate daily loss for the solar panel/group of solar panels.
4. Estimate soiling rates for the solar panel/group of solar panels on a monthly basis using historical soiling.
5. Use historical rainfall rates at the closest national weather station to generate a hypothetical rainfall calendar for a forecast period (e.g., 365 days in the future).
6. Modify the soiling rate by the monthly rate or environmental washing to produce a new soiling value.
7. Repeat for each day in the forecast, aggregating the daily loss amounts and tracking the new soiling amount for each day, then repeat the entire process many times.
8. Sort and smooth the forecast, providing median and percentile soiling loss values.
9. Calculate loss avoided over a 3-month period if cleaning were to occur, and determine the soonest date when 3-month loss avoidance≤cleaning cost.

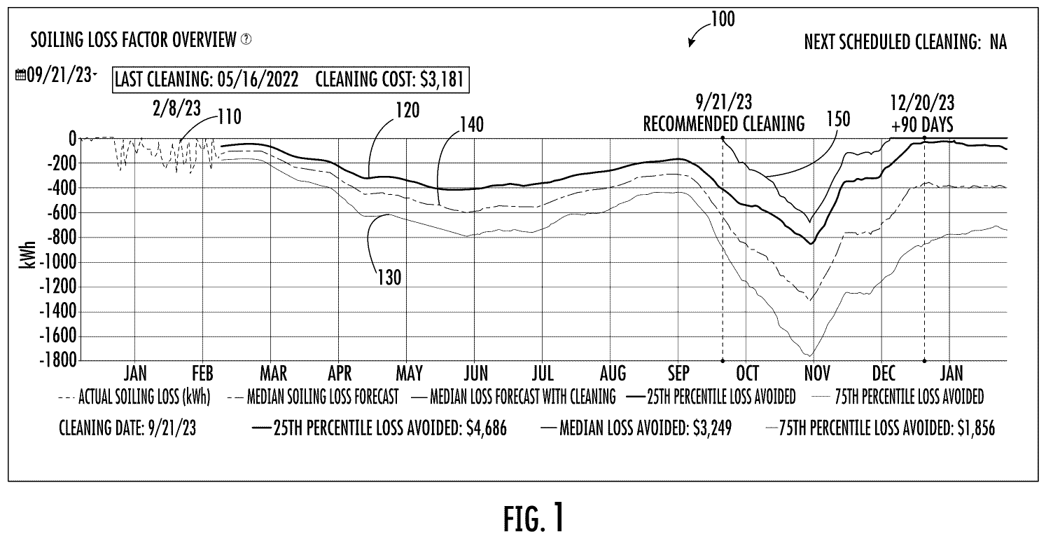

FIG. 1 illustrates a user interface 100 that can be displayed by the software tool on a user device (e.g., a smart phone, a personal computer, etc.). As shown in FIG. 1, the user interface 100 displays predicted soiling losses for a solar-panel site according to some embodiments of the present invention. In FIG. 1, actual (i.e., measured/historical) soiling loss in kilowatt-hours (kWh) is indicated by line 110. Lines 120 and 130 represent 25^{th} percentile and 75^{th} percentile soiling-loss forecasts (which may be used to determine 25^{th} percentile and 75^{th} percentile avoided losses), respectively, for the solar-panel site. Line 140 represents the median soiling lost forecast. Line 150 represents the median loss forecast with cleaning at a selected date (Sep. 21, 2023) in the future. Accordingly, line 150 represents soiling loss that will occur if the cleaning is performed. Line 150 may thus be referred to herein as a “post-cleaning soiling-loss forecast.” In some embodiments, the post-cleaning soiling-loss forecast may extend beyond 90 days, such as by extending 120 days (or until year-end).

The shaded area bounded by lines 140 and 150 on the top and bottom and by the dashed vertical lines on the left and right represents the cumulative loss that would be avoided were cleaning to occur on the specified date. The shaded area thus represents soiling loss that will be avoided if the cleaning is performed. For example, the shaded area may illustrate savings, in kWh, that cleaning will provide. The specified cleaning date is selected by the system because the accumulated soiling loss in dollars over any prior 90-day period is less than (or equal to) the cost of cleaning. Washing sooner than this date does not allow the site to recover the cost of a cleaning within 90 days.

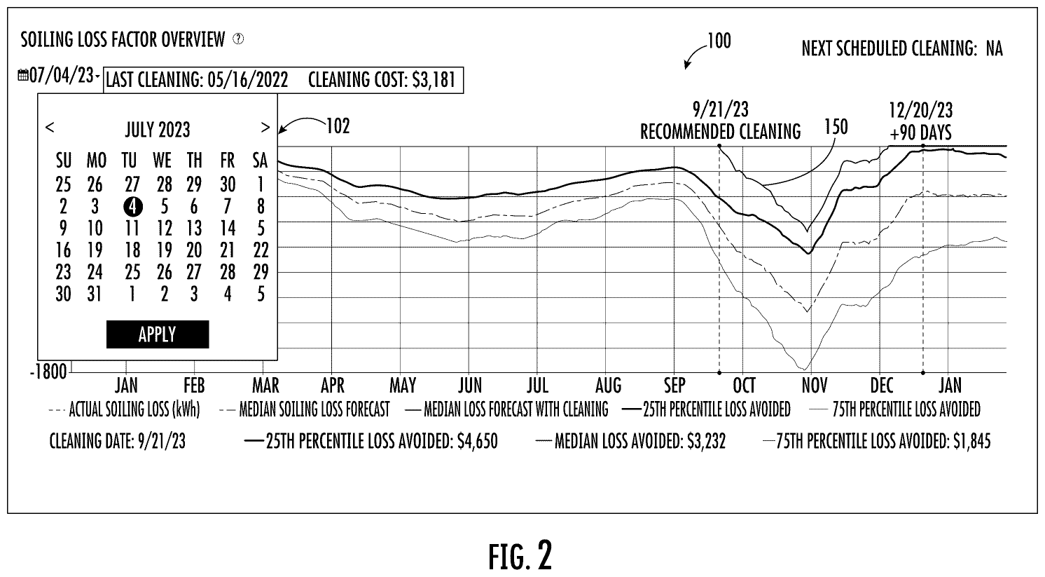

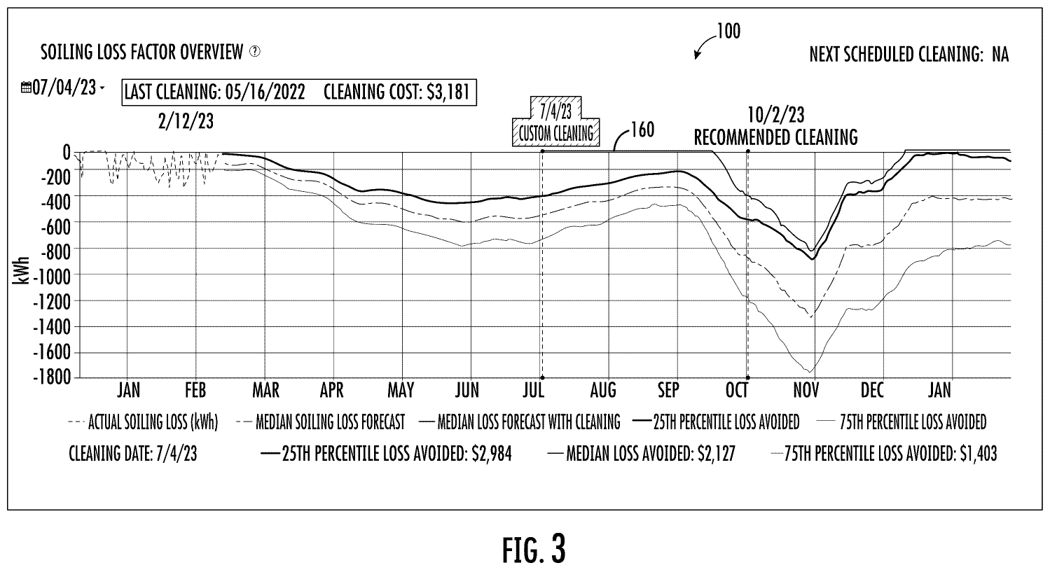

FIG. 2 illustrates the user interface 100 of FIG. 1 with a pop-up calendar 102 displayed and from which a user can manually select a future date for cleaning the solar panels at a particular solar-panel site. In FIG. 2, the user has selected Jul. 4, 2023 in the pop-up calendar 102. The software tool calculates the amount of soiling loss that will be avoided during the next 90 days from the selected cleaning date to assess the profitability of cleaning the solar panels on that date. In FIG. 3, the median soiling-loss forecast after cleaning on the chosen date (Jul. 4, 2023) for the rest of the year is displayed by line 160. Moreover, the median soiling-loss avoided (which is represented by the shaded area in FIG. 3) after cleaning can be determined by calculating a difference between line 160 and the median soiling loss forecast during the 90 days.

According to embodiments of the present invention, to determine the current soiling loss for solar panels at a site, the previous 60 days are analyzed as to whether soiling is taking place. This may be done, for example, using a nrel software model (National Renewable Energy Laboratory) within PVlib, which is an open-source Python software library for modeling the electrical performance of a solar PV system. The nrel software model will provide a value for solar panels on a site-by-site basis for the current amount of soiling loss that is taking place. This is used for the starting point for future forecast losses.

To use historical production data to produce a daily estimate of expected PV production, the distribution of the energy produced by a solar panel/group of panels in a historical month is fitted to a continuous probability distribution, such as a Weibull distribution, and then future days are drawn from that distribution based on the month in which they occurred. This forecast is performed many times as a result of Monte Carlo simulation. As such, there is a range of possible values of expected PV production for each day in the future based on the historical results.

The soiling rate is the amount of output loss due to contamination (e.g., dirt/dust/pollen) and/or other material that has built up on a solar panel. PVlib is used to estimate the soiling rate by analyzing the expected and actual PV performance of a solar-panel site.

Using one year as the forecast period, a single simulation will include generating a rainfall calendar and a PV production calendar for the one-year forecast period. There is a forecast for each day in the 365 days of the one-year forecast period. Starting on day 1, we have a current soiling loss, and a forecast for the expected PV production and the amount of rainfall. Given the rainfall information from historical data, one of two things are done: 1) if rainfall is over a threshold (as determined by region), soiling loss will decrease based on the historical demonstration that precipitation cleans panels; or 2) if rainfall is not over a threshold, then the soiling loss is increased by the monthly soiling rate, as calculated above. This produces a new soiling-loss amount for day one in the future. This new soiling amount is used as the input for the same process on the next day.

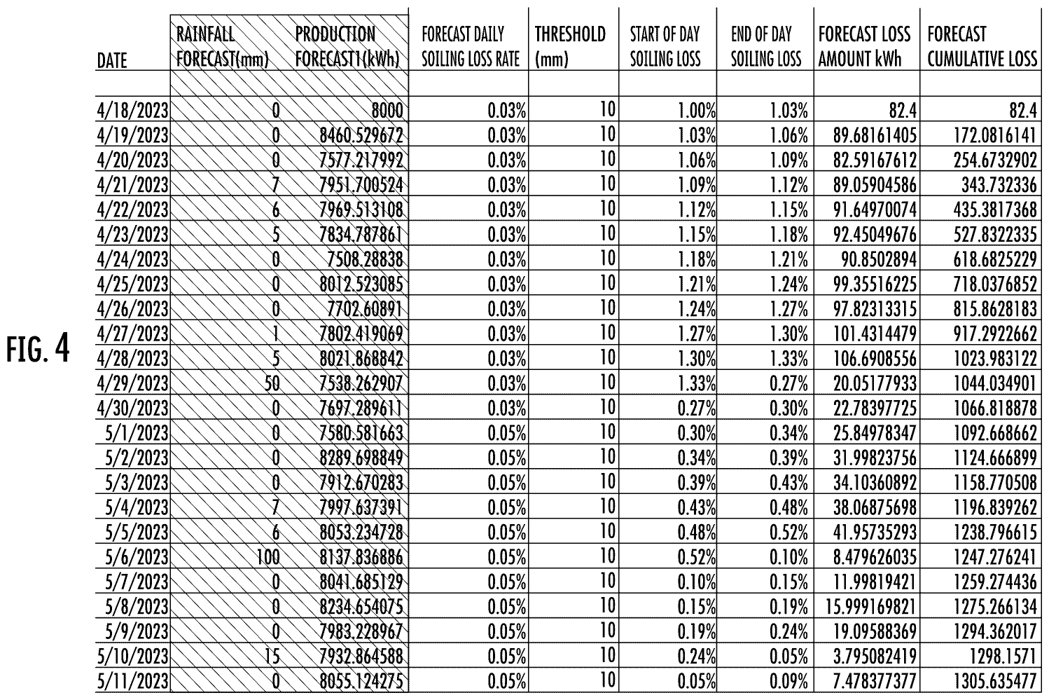

FIG. 4 is a table that illustrates forecast rainfall data and forecast soiling-loss data for each day in a future time period as determined by the software tool of the present invention. The forecast daily soiling-loss rate is the historical mean loss on each day of a month as determined by the nrel model. The threshold in mm represents the amount of daily rainfall required to cause an environmental cleaning event, as opposed to a day on which there is a net increase in soiling. At the start of each day, a current amount of energy is being lost to soiling, and if an environmental cleaning event occurs, this amount is reduced by 80%, and if the rainfall is not above threshold, then the daily soiling-loss rate is added to the current amount of soiling loss instead. This results in a new end-of-day soiling loss. Given this rate of loss and the amount of production forecast for the site, we are able to predict the forecast loss amount, and accumulation of these amounts from a selected reference date defines the forecast cumulative loss.

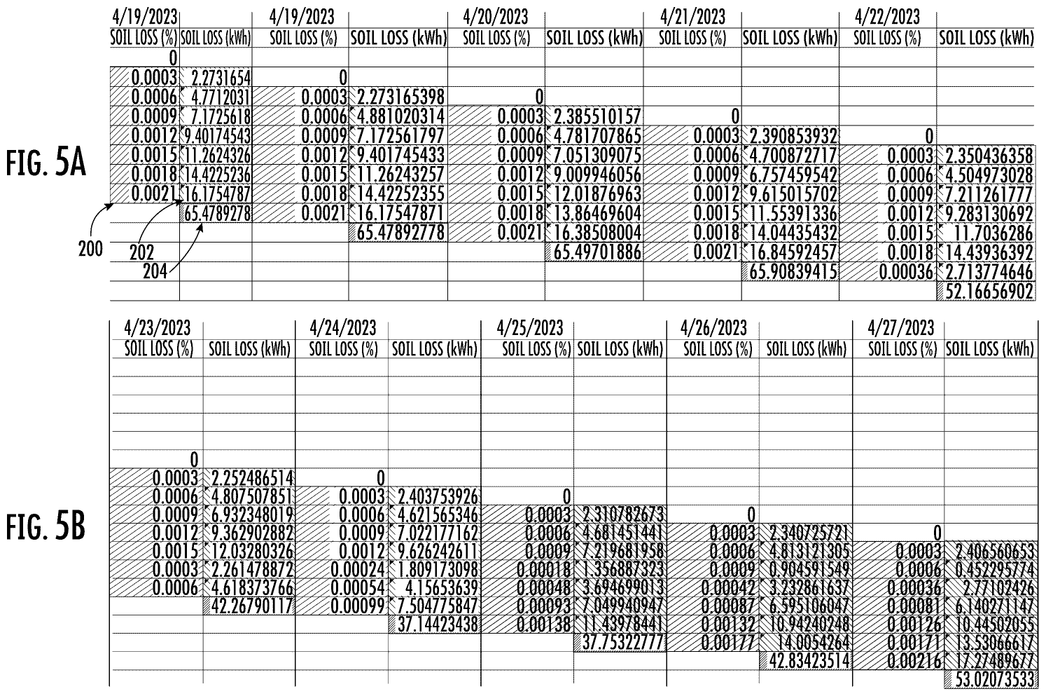

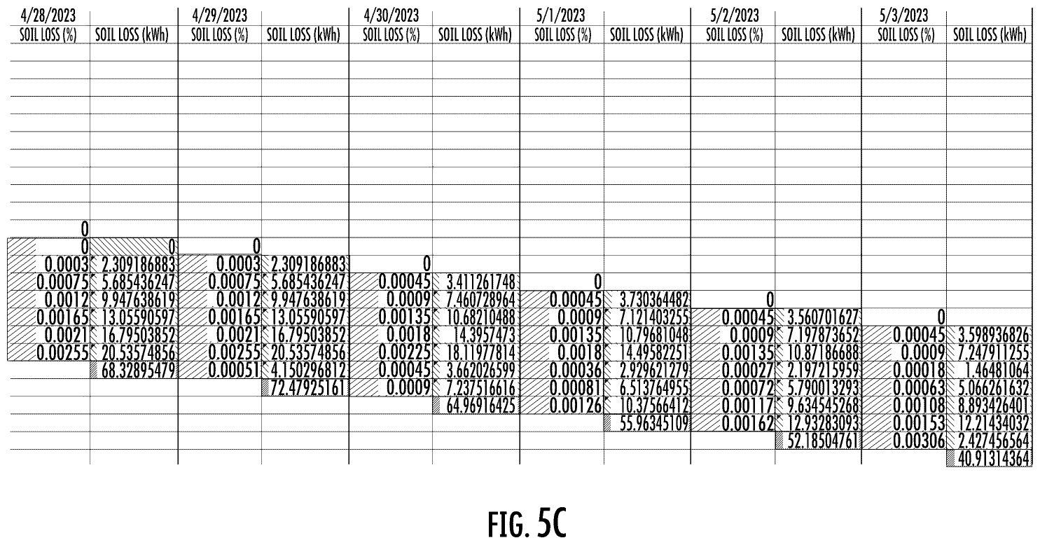

FIGS. 5A-5C illustrate soil loss for each day in the future time period as determined by the software tool. The left column 200 for each date contains the daily soiling loss percentage and the right column 202 for each date contains the soiling loss in kWh for a seven (7) day period following a cleaning of the solar panels at a site. The total 204 at the bottom of each right column 202 is the cumulative predicted loss over the 7-day period if a cleaning of the solar panels were to occur. Typically, a ninety (90) day future period would be used, but the 7-day period is illustrated for ease of reference. These figures illustrate how loss avoidance can vary on future dates, and is based on the forecast production, expected rainfall, historically estimated monthly soiling rates demonstrated by the specific site, and current soiling-loss amounts.

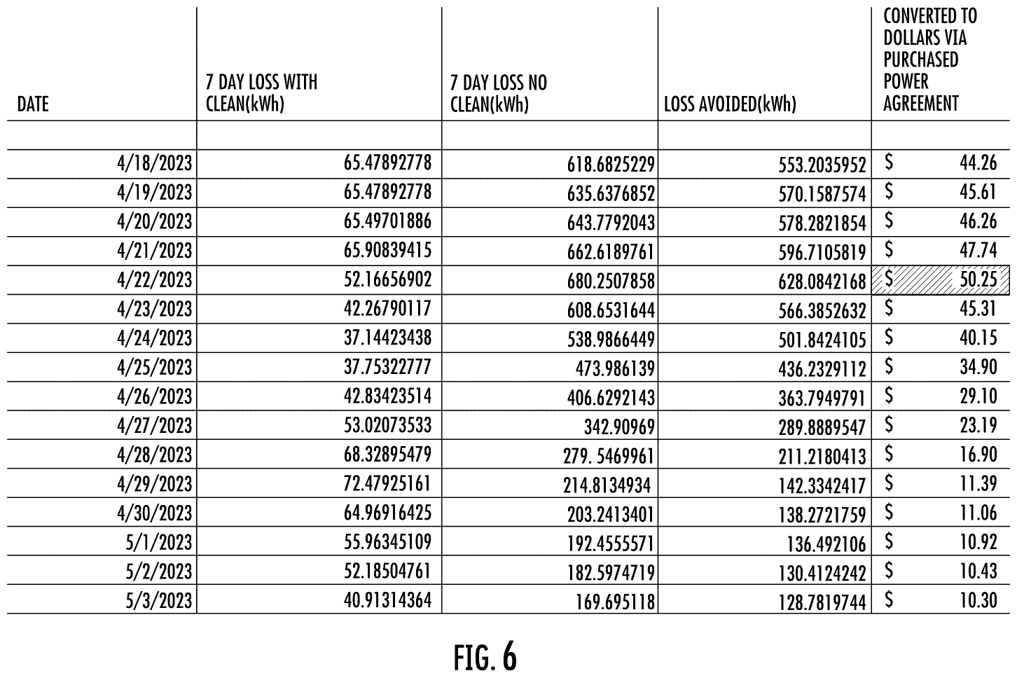

FIG. 6 is a table that illustrates loss avoidance in kWh converted to dollars. For the 20) selected future cleaning date, Apr. 22, 2023, the loss in dollars is $50.25. Thus, if it costs $50 to clean the solar panels at the site, then the next cleaning date that is recommended by the software tool is the first date on which the avoided loss exceeds $50. By determining the earliest day on which cleaning costs can be recouped, profit is optimized.

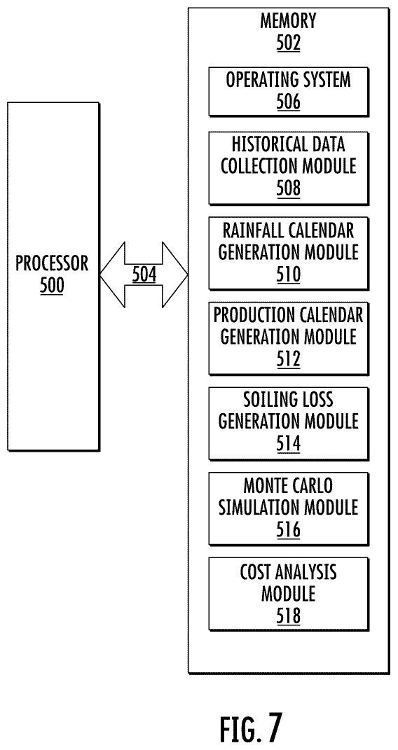

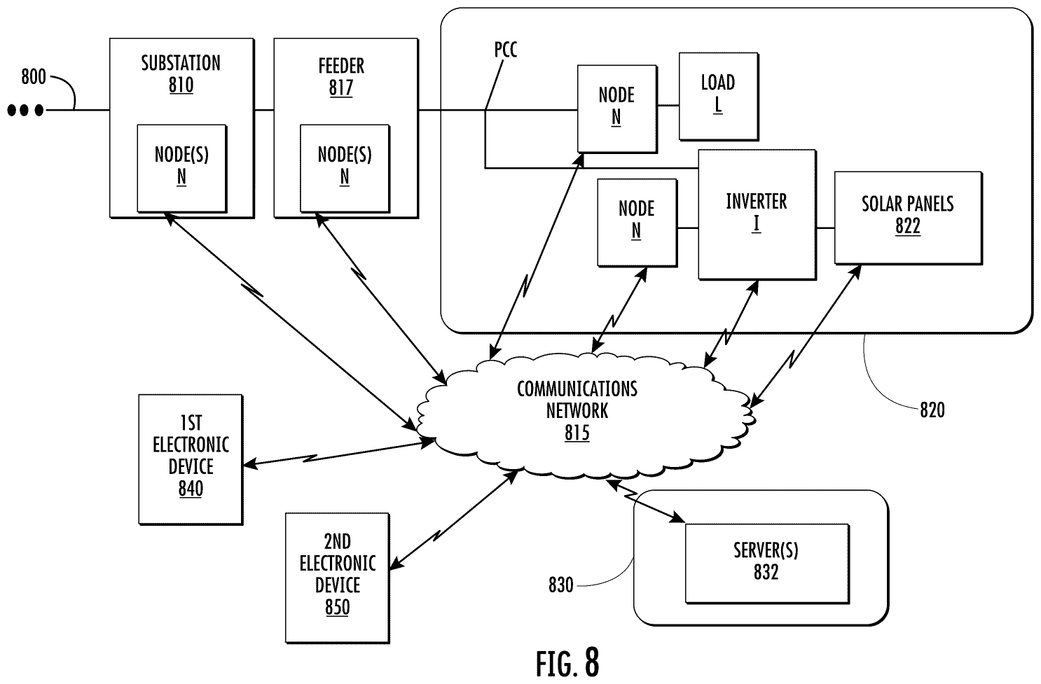

FIG. 7 illustrates an example processor 500 and memory 502 that may be used to forecast how much output a solar-panel site will lose due to soiling and to recommend the next profitable cleaning date, according to some embodiments of the present invention. The processor 500 communicates with the memory 502 via an address/data bus 504. The processor 500 may be, for example, a commercially available or custom microprocessor. The memory 502 is representative of the overall hierarchy of memory devices containing the software and data used to forecast how much output a solar-panel site will lose due to soiling and to recommend the next profitable cleaning date as described herein, in accordance with some embodiments. The memory 502 may include, but is not limited to, the following types of devices: cache, ROM, PROM, EPROM, EEPROM, flash, SRAM, and DRAM.

As shown in FIG. 7, the memory 502 may hold various categories of software and data: an operating system 506, a historical data collection module 508, a rainfall calendar generation module 510, a PV production calendar generation module 512, a soiling loss generation module 514, a Monte Carlo simulation module 516, and a cost analysis module 518. The operating system 506 controls operations of a server (or group of servers) or a user device, such as a smart phone or personal computer, that implements the software tool of the present invention. In particular, the operating system 506 may manage the resources of the server(s) or user device and may coordinate execution of various programs (e.g., the historical data collection module 508, the rainfall calendar generation module 510, the PV production calendar generation module 512, the soiling loss generation module 514, the Monte Carlo simulation module 516, and the cost analysis module 518, etc.) by the processor 500.

The historical data collection module 508 comprises logic for collecting historical rainfall data (e.g., multiple years of data, etc.) at a solar-panel site, aggregated by day (e.g., in millimeters of precipitation), and for collecting historical PV performance data (e.g., multiple years of data, etc.) for the solar panels at the site. The rainfall calendar generation module 510 comprises logic for generating a plurality of rainfall calendars for a future period of time using the historical rainfall data. Each rainfall calendar is broken down by month, with each day in the month having a rainfall amount, for example in millimeters, inches, or some other unit of measurement. Each rainfall calendar will be different, where some will have more rain, some less, some will have rain clustered together, some will be more spread out, but in aggregate, they will correspond to the underlying statistical log-normal property of rainfall.

The PV production calendar generation module 512 comprises logic for generating a plurality of solar panel PV production calendars for the future period of time using the historical PV production data for the solar panels at the site. The soiling loss generation module 514 comprises logic for producing an estimated soiling loss for the solar panels at the site for each day of the forecast period. The Monte Carlo simulation module 516 comprises logic for outputting a range of soiling-loss forecasts based on the historical precipitation data for each day, soiling rates, and the expected PV production data. Accordingly, 25^{th} percentile, median, and 75^{th} percentile forecasts may be generated based on the range of soiling-loss forecasts. The cost analysis module 518 comprises logic for comparing the median soiling loss and the cost of cleaning to determine when these values are the same. A recommendation is then made to clean the solar panels on that date.

FIG. 8 is a schematic illustration of a grid 800 and a microgrid 820, according to various embodiments. The grid 800 may be a utility grid such as an electric grid. A substation 810 of the grid 800 may be an electric utility substation that includes one or more transformers. Though one substation 810 is illustrated in FIG. 8, the grid 800 may, in some embodiments, include more than one (e.g., two, three, four, five, dozens, hundreds, or more) substation 810.

A feeder 817 may be connected between output terminals of the substation 810 and input terminals of the microgrid 820. The feeder 817 may be referred to as a “distribution feeder” or a “distribution feeder circuit.” A plurality of distribution feeder circuits may be connected to the substation 810 and may extend in different directions to serve various customers. The feeder 817 and the microgrid 820 may be referred to as being “downstream” from the substation 810.

The substation 810 and the microgrid 820 may communicate with a communications network 815, and may be electrically tied to each other via a Point of Common Coupling (PCC). The communications network 815 may include one or more wireless or wired communications networks, such as a local area network (e.g., Ethernet or Wi-Fi) or a Wide Area Network (e.g., a cellular network, Ethernet, or a fiber (such as fiber-optic) network).

In some embodiments, the microgrid 820 may include apparatuses, such as nodes N, that transmit and receive data via the communications network 815. For example, the nodes N of the microgrid 820 may communicate with each other via the communications network 815. Additionally or alternatively, the nodes N of the microgrid 820 may communicate via the communications network 815 with nodes that are external to the microgrid 820. As an example, the nodes N of the microgrid 820 may communicate via the communications network 815 with one or more computer servers 832, which may be at one or more data centers 830. The server(s) 832 may include one or more processors 500 (FIG. 7) and one or more memories 502 (FIG. 7), where each memory 502 may include one or more of the modules 508-518 shown in FIG. 7. Moreover, the first electronic device 840 may, in some embodiments, include one or more processors 500 and one or more memories 502. According to some embodiments, the server(s) 832 may be cloud servers in a cloud-computing environment. The server(s) 832 may thus be physically located anywhere.

In some embodiments, the microgrid 820 may include various distributed energy resources, which may be connected to respective inverters I. A distributed energy resource may be any type of generator. For example, a distributed energy resource may be a solar (i.e., PV) generation system, a wind power generation system, or a diesel generator. Other examples of a distributed energy resource include a battery, a flywheel, a controllable load, a capacitor, and any other energy storage system. In some embodiments, multiple devices may be behind a single inverter I. As an example, a single inverter I may be the inverter for both a battery and a solar generation system. Each inverter I may be configured to convert a variable Direct Current (DC) output of one or more distributed energy resources into a utility frequency Alternating Current (AC) that can be fed into a commercial electrical grid (e.g., the grid 800) or be used by a local, off-grid electrical network. In some embodiments, the microgrid 820 may include a load L, which may be an AC load or a DC load. For simplicity of illustration, solar panels 822 are shown as a distributed energy resource in the microgrid 820, while various other distributed energy resources that can be included in the microgrid 820 are omitted from view in FIG. 8.

Though an inverter I is illustrated in FIG. 8, it will be understood that inverters are merely one example among various types of power converters that may be coupled to the distributed energy resources. For example, each distributed energy resource may be coupled to a respective power converter that may be configured to convert (i) from DC to DC (e.g., for a DC microgrid) and/or (ii) from DC to AC.

Each inverter I may be adjacent, and communicatively coupled to, a respective node N. Additionally or alternatively, the node N may be adjacent, and communicatively coupled to, the distributed energy resource(s) that the inverter I is connected to. As used herein with respect to a node N, the term “adjacent” refers to a distance of no more than one hundred meters from the node N. As an example, the distance may be no more than thirty feet or no more than thirty meters.

For simplicity of illustration, a single microgrid 820 is shown in FIG. 8. In some embodiments, however, multiple microgrids 820 may be coupled to the grid 800. As an example, several microgrids 820 that include respective groups/systems of solar panels 822 may be located at different respective physical locations. Each of these locations may be referred to herein as a respective “site” that is shared by multiple solar panels 822 of a solar-panel group/system. According to some embodiments, the different sites may be spaced apart from each other by at least 1 mile, at least 5 miles, at least 10 miles, or longer distances.

A human solar-site manager may be responsible for managing the different sites, and may use a first electronic device 840 to monitor the sites (e.g., 10-15 different sites). The solar-site manager is thus a person who may be physically located outside of a particular site (e.g., a particular microgrid 820) while managing that site. The electronic device 840 may be, for example, a mobile phone, a tablet computer, a laptop computer, or a desktop computer. The electronic device 840 has a graphical user interface (GUI), such as the user interface 100 (FIG. 1), that can display data from the solar panels 822, and/or data from the server(s) 832, to help the solar-site manager manage the solar panels 822. The GUI is displayed on a display screen of the first electronic device 840. In some embodiments, a second electronic device 850 that is used by an entity other than the solar-site manager may receive instructions to clean the solar panels 822 via the communications network 815 from the first electronic device 840 and/or the server(s) 832.

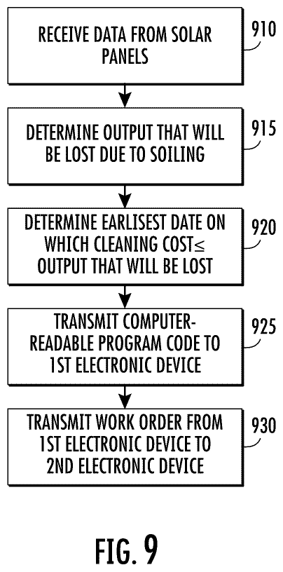

FIG. 9 is a flowchart showing operations for mitigating soiling of solar panels 822 (FIG. 8) that share a PV power-generation site, such as a microgrid 820. As shown in FIG. 9, the operations may include receiving (Block 910) data from the solar panels 822. For example, referring to FIG. 8, a server 832 (or group of servers) may receive the data via a communications network 815. In some embodiments, the solar panels 822 may transmit the data directly via the communications network 815. In other embodiments, an inverter I, or a node N, that is adjacent and coupled to the solar panels 822 may transmit the data.

The data may comprise PV output data for the solar panels 822. As an example, the PV output data may comprise daily PV output data for the solar panels 822. According to some embodiments, the daily PV output data may be total PV output data for all of the solar panels 822 at the shared site for the previous day. The solar panels 822 may thus transmit PV output data to the server(s) 832 on a daily basis, and the PV output data that is transmitted today may be data indicating yesterday's PV output. Moreover, the server(s) 832 may aggregate daily PV output data over multiple months (e.g., two, three, or more months) or even multiple years (e.g., two, three, four, five, or more years). The PV output data may be received in a format of, for example, kWh.

Based on aggregate PV output data received from the solar panels 822 that share the site, the server(s) 832 can determine (Block 915) a predicted (i.e., forecast, future) amount of PV output by the solar panels 822 that will be lost due to soiling of the solar panels 822. The aggregate data may be aggregated over multiple years and may include, for example, data as recent as that indicating yesterday's PV output. Moreover, the predicted amount of PV output that will be lost may be provided in a format of, for example, kWh and/or dollars.

In some embodiments, the predicted amount of PV output that will be lost due to soiling may be forecast over a multi-month future time period and may include a median (instead of or in addition to, e.g., 25^{th} percentile or 75^{th} percentile) forecast of soiling loss by the solar panels 822, as represented by the line 140 in FIG. 1. The multi-month period may include at least two months. For example, the multi-month period may include more than 60 days and no more than 90 days. According to some embodiments, the multi-month period includes at least three months and no more than twelve months. Moreover, the predicted amount of PV output that will be lost due to soiling may be determined by calculating expected power production (i.e., expected PV output) for the solar panels 822 at the site over the multi-month period.

In addition to being based on historical (e.g., aggregate) PV output data, the predicted amount of PV output that will be lost due to soiling may be further based on other factors, including weather data for the site where the solar panels 822 are located. Weather data may include historical rainfall data for the site. As an example, the rainfall data may include historical amounts (e.g., in inches or millimeters) of rainfall that have occurred for the site on a daily, weekly, monthly, and/or annual basis (e.g., over a period of one, two, or more years). In some embodiments, the rainfall data may be based on rainfall measurements performed at the site. In other embodiments, the rainfall data may be based on rainfall measurements performed at a location that shares a ZIP code (or a town/city/county) with the site. The server(s) 832 may use the historical rainfall data to forecast future rainfall amounts over a multi-month future time period. As rainfall can reduce soiling, the forecast future rainfall amounts can be used to determine the predicted amount of PV output that will be lost due to soiling over the multi-month period.

The predicted amount of PV output that will be lost due to soiling of the solar panels 822 may be determined by performing a Monte Carlo simulation using the PV output data from the solar panels 822 and using the weather data. For example, the Monte Carlo simulation may be performed by the server(s) 832.

The server(s) 832 may determine (Block 920) an earliest calendar date, over the multi-month period, on which (a) a cost of cleaning the solar panels 822 that share the site will be less than or equal to (b) a cost of the predicted amount of PV output that will be lost due to soiling. The cost of the predicted amount of PV output that will be lost due to soiling may be in a format of, for example, kWh and/or dollars. As an example, that cost may be the median forecast of soiling loss as represented in kWh and/or dollars. In some embodiments, the server(s) 832 may determine the earliest calendar date by comparing, for each day over the multi-month period, the two costs (a) and (b) with each other. Moreover, the cost of cleaning the solar panels 822 may be, for example, the historical cost of cleaning (e.g., the cost of the most recent cleaning of) the solar panels 822 at the site and/or the historical cost of cleaning solar panels 822 at a different site.

The earliest calendar date may, in some embodiments, be determined by forecasting an amount of soiling loss for the solar panels 822 that will be avoided over the multi-month period. As an example, determining a forecast amount of soiling loss that will be avoided can include determining a daily forecast soiling loss for the solar panels 822 over the multi-month period.

The earliest calendar date may also be referred to herein as a “recommended date” for cleaning the solar panels 822, as it is the first date on which it will be profitable (or at least cost-neutral) for an electric utility to clean the solar panels 822. On any date before the recommended date, the cost of cleaning the solar panels 822 is higher than the forecast soiling loss. For example, the cost of cleaning the solar panels 822 may be higher than an aggregate soiling-loss cost for the solar panels 822 over any multi-month period that starts before the recommended date.

Referring to FIGS. 8 and 9, the server(s) 832 may transmit (Block 925) computer-readable program code to the first electronic device 840 via the communications network 815. The computer-readable program code may include, for example, an instruction to display the earliest calendar date on a GUI of the first electronic device 840. In some embodiments, the computer-readable program code may be automatically transmitted in response to receiving PV output data from the solar panels 822. Accordingly, receiving PV output data can trigger the server(s) 832 to automatically (i) determine PV output that will be lost due to soiling of the solar panels, (ii) determine the earliest calendar date, and (iii) transmit the computer-readable program code. For example, the server(s) 832 may automatically transmit computer-readable program code comprising an updated earliest calendar date to the first electronic device 840 on a regular basis, such as daily, weekly, monthly, or quarterly. In other embodiments, the computer-readable program code may be transmitted in response to a user request, by a user of the first electronic device 840 via the GUI of the first electronic device 840, for an earliest calendar date. The user may be the solar-site manager.

In some embodiments, the computer-readable program code transmitted to the first electronic device 840 may include instructions to display any one or more of the lines 110-160 and/or the calendar 102 shown in FIGS. 1-3 via the GUI of the first electronic device 840. For example, the computer-readable program code may include instructions to display, via the GUI, (i) the predicted amount of PV output that will be lost due to soiling of the solar panels 822 and (ii) the earliest calendar date for cleaning of the solar panels 822 without incurring a cleaning cost that exceeds the predicted amount of PV output that will be lost due to soiling.

According to some embodiments, the calendar 102 (FIG. 2) may be displayed on the GUI of the first electronic device 840. The calendar 102 may show user-selectable dates (e.g., within a particular month). The user of the first electronic device 840 may provide, via the GUI, a user selection of a particular one of the user-selectable dates. In response to the user selection, the GUI may then display, via the GUI, a soiling loss for the solar panels 822 that will be avoided if cleaning of the solar panels 822 occurs on the particular date that the user selected.

Referring still to FIGS. 8 and 9, a work order may be transmitted (Block 930) to the second electronic device 850 to clean the solar panels 822 at the site. According to some embodiments, the server(s) 832 may automatically transmit the work order to the second electronic device 850 in response to transmitting the computer-readable program code to the first electronic device 840. In other embodiments, the user of the first electronic device 840 may manually transmit the work order from the first electronic device 840 to the second electronic device 850. Moreover, the work order may be embodied in computer-readable program code that includes instructions to display the work order on a GUI of the second electronic device 850.

For simplicity of explanation, a work order is described herein as an example of an electronic communication that may be transmitted to the second electronic device 850 to schedule cleaning of the solar panels 822. Other examples, however, include transmitting an electronic notification (other than a work order), such as an email, a text message, or a notification for an application that is present on the second electronic device 850, to clean the solar panels 822. According to some embodiments, a user of the second electronic device 850 may be an entity that has cleaned the solar panels 822 in the past and/or will clean the solar panels 822 on (or shortly after) the earliest calendar date that is determined by the server(s) 832.

### Example

The following is an example of the steps for estimating a cleaning date for a single solar-panel site, according to some embodiments of the present invention.

### A. Data Collection

a. 2 years historical performance measures, aggregated by day (kWh)
b. 5 years historical rainfall data, aggregated by day (mm precipitation)
c. 2 years historical expected performance data kWh (based on irradiance measures at the site, inverter and panel capacity, and temperature).

### B. Rainfall Calendar Generation

a. Break rainfall rates apart by month.
b. Model each month independently, performing a log normal fit on the rainfall amounts.
c. For each date in the 1 year forecast period, draw a value from the appropriate monthly rainfall distribution (one set of these values starting from the day after the current date and extending out one year is considered a rainfall calendar).
d. Repeat many times—each calendar will be different, some will have more rain, some less, some will have rain clustered together, some will be more spread out, but in aggregate, they will correspond to the underlying statistical log-normal property of rainfall.
e. Label each rainfall calendar from 1 to n.

### C. Production Calendar Generation

a. Break expected production rates apart by month
b. Model each independently based on a Weibull distribution fit.
   i. This was the best fit across all the distributions, and made sense given that the maximum expected performance is capped by the clear sky irradiance value, and all days have some amount of irradiance less than or equal to that clear sky amount. We wouldn't expect a normal distribution, for example, because the positive tail is impossible to produce, because of the physics of how much the sun can shine on an area during the day, and how much solar energy reaches earth.
c. For each date in the 1 year forecast period, draw a value from the appropriate monthly expected production distribution (one set of these values starting from the day after the current date and extending out one year is considered a production calendar)
d. Repeat as many times as we′d like to run Monte Carlo—each calendar will be different, but in aggregate, they will correspond to the underlying statistical Weibull property of production.
e. Label each production calendar from 1 to n

### D. Calculate Monthly Loss Rates

a. Using the nrel model, which identifies decreasing linear trends that can be attributed to soiling, estimate the average monthly soiling rates. This means that for a day in a given month, and with current soiling amount x %, that if no manual or environmental washing occurs, the soiling loss the following day will be x %+the soiling rate.

### E. Calculate Current Soiling Loss

a. Using the nrel model and pvlib, calculate the current soiling loss using historical performance and expected data.

### F. Establish the Rainfall Cleaning Thresholds

a. Based on the makeup of the soiling in different regions, different amounts of rainfall are required to cause environmental washing.
   i. For example, pollen in the southeast is stickier than dust in the southwest, and so the rainfall threshold for cleaning is higher for our GA sites than for those in southern California.
   ii. Establish the target threshold for each site independently.

### G. Estimate Loss for Each Date in the First Monte Carlo Model

a. Using the current soiling loss, rainfall calendar(0), production calendar(0), and the estimated monthly loss rates, we can now generate the soiling loss for day 1 of the forecast.
   i. Let the current soiling loss be s[0],
   ii. The rainfall amount on day 1 of the rainfall calendar be rf[0],
   iii. The cleaning threshold as threshold
   iv. The monthly soiling rate based on the month as soilrate[month]
b. If rf[0]<=threshold, then:
   i. s[1] should be set equal to s[0]+soilrate[month]
c. if rf[0]>threshold, then:
   i. s[1] should be set equal to s[0]*0.2
d. The 0.2 parameter is an 80% clean as determined experimentally in table 2 at www.ncbi.nlm.nih.gov/pmc/articles/PMC7960939/
e. This is then repeated for each subsequent day, using the next value in the rainfall calendar, the previously calculated result in the soiling loss measure
f. This will produce an estimated soiling loss for each day of the forecast year

### H. Estimate the Daily Loss

a. For each date, we now have a soiling loss percentage
b. Multiply s[x]*prod[x] for each day x in the year forecast to produce an estimate for each day of how many kWh were lost due to soiling

### I. Repeat the Forecast of the Soiling Loss for Each Day of Each of the Rainfall Calendars

What we now have is a collection of daily estimates of soiling loss percentages, and lost production amounts (kWh). We have an agreement with each customer about how much this generated power is worth, so we can directly convert lost kWh to lost dollars. We also know what it cost last time to pay someone to clean the solar panels, so the next step is to balance out the cost of a cleaning with the cost of not cleaning—the lost dollars due to dirty panels.

### J. Calculate Quartiles for Dollars Lost

a. On each day of the forecast, we can look at the output across all N models that we produced using the above approach. On that date, there will be a daily and a daily cumulative amount of dollars lost. The cumulative dollars lost is the sum of all dollars lost from that date back to current, and the daily is just the dollars lost on that date.
b. Each forecast date, we can calculate the median of cumulative dollars lost, as well as the lower and upper 25th percentiles.
c. For each of these values, we smooth the data by using a rolling 2 week average and display them to the user

### K. Calculate Loss Avoidance

a. An electric utility may seek to recoup cleaning costs within 90 days of the cleaning.
b. Next, we compare the median soiling loss and the cost of cleaning. When these values are the same, avoided loss and cleaning costs are balanced, and once losses exceed cleaning costs, we should clean.
c. If we were to clean the system tomorrow, the soiling loss would be set to zero
d. Then soiling loss would begin to accrue again over the following 90 days.
e. If we aggregate the median loss from the day of the clean until 90 days out, and compare that to the same 90 day loss forecast, then the difference between them is the avoided loss.
f. The first date in the future where there is a hypothetical clean and the avoided loss over the subsequent 90 days is greater than the cost of a clean, is the date that we recommend a cleaning
g. In the tool, the user can also slide the proposed cleaning date around to get a more complete understanding of the quartile losses on different possible cleaning dates.

Methods of solar-panel-soiling mitigation according to embodiments of the present invention may provide a number of advantages. These advantages include helping a solar-site manager optimize when to clean solar panels 822 (FIG. 8) based on a predicted amount of PV output that will be lost due to soiling of the solar panels 822. The predicted amount of PV output may be an estimate (e.g., a forecast) of future PV output that will be lost due to soiling, and may be based on factors such as rainfall data and expected PV output (which can be based on historical PV output). The solar-site manager can thus precisely select a cleaning date that maximizes PV output and/or how quickly the cost of cleaning can be recouped due to increased PV output following cleaning.

In some embodiments, a cloud-computing environment (e.g., which may include server(s) 832 (FIG. 8)) may be used to perform one or more Monte Carlo simulations to determine (i) the predicted amount of future PV output and (ii) a recommended date for cleaning the solar panels 822. Moreover, a GUI of an electronic device 840 (FIG. 8) that is used by a manager of the site that includes the solar panels 822 may display the recommended date to the manager. For example, the GUI may display a web browser, or other application, that is running on the electronic device 840 and that receives the recommended date from the cloud-computing environment via a communications network 815 (FIG. 8). The web browser, or the other application, may display the recommended date along with any one or more of the lines 110-160 and/or the calendar 102 shown in FIGS. 1-3. Computer-readable program code including instructions to display the recommended date and/or any one or more of the lines 110-160 and/or the calendar 102 may be received by the web browser, or the other application, from the cloud-computing environment via the communications network 815. A combination of the cloud-computing environment and the web browser, or the other application, can thus be used to more precisely and cost-effectively select a cleaning date for the solar panels 822.

Like numbers refer to like elements throughout. In the figures, certain components or features may be exaggerated for clarity, and broken lines illustrate optional features or operations unless specified otherwise. In addition, the sequence of operations (or steps) is not limited to the order presented in the figures and/or claims unless specifically indicated otherwise. Features described with respect to one figure or embodiment can be associated with another embodiment or figure though not specifically described or shown as such.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.,” which derives from the Latin phrase “exempli gratia,” may be used to introduce or specify a general example or examples of a previously mentioned item, and is not intended to be limiting of such item. The common abbreviation “i.e.,” which derives from the Latin phrase “id est,” may be used to specify a particular item from a more general recitation.

It will be understood that though the terms first, second, third, etc., may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

The terms “about” and “approximately”, as used herein with respect to a value or number, means that the value or number can vary by +/−twenty percent (20%).

The foregoing is illustrative of the present invention and is not to be construed as limiting thereof. Though a few example embodiments of this invention have been described, those skilled in the art will readily appreciate that many modifications are possible in the example embodiments without materially departing from the teachings and advantages of this invention. Accordingly, all such modifications are intended to be included within the scope of this invention as defined in the claims. The invention is defined by the following claims, with equivalents of the claims to be included therein.

What is claimed is:

1. A method for solar-panel-soiling mitigation, the method comprising:
displaying, via a graphical user interface (GUI) on an electronic device, a predicted amount of photovoltaic (PV) output that will be lost due to soiling of solar panels that share a site; and
displaying, via the GUI, a recommended date for cleaning the solar panels, wherein the recommended date is an earliest calendar date on which a cost of the cleaning of the solar panels is less than or equal to a cost of the predicted amount of PV output that will be lost due to soiling.

2. The method of claim 1, further comprising:
transmitting, from the electronic device to a second electronic device, a work order or other electronic notification for the cleaning of the solar panels, wherein the work order or other electronic notification is based on the earliest calendar date.

3. The method of claim 2, wherein the second electronic device is used by an entity that performs the cleaning of the solar panels.

4. The method of claim 1, wherein the predicted amount of PV output that will be lost due to soiling is determined based on:
weather data for the site; and
expected PV output for the site.

5. The method of claim 4, wherein the weather data comprises rainfall data for the site.

6. The method of claim 1, wherein the earliest calendar date is determined based on a soiling loss for the solar panels that will be avoided, over a multi-month future time period starting on the recommended date, if the cleaning occurs on the recommended date.

7. The method of claim 6, wherein the soiling loss for the solar panels that will be avoided over the multi-month future time period is determined based on:
a daily soiling loss for the solar panels over the multi-month future time period.

8. The method of claim 6, wherein the cost of the cleaning of the solar panels is higher than an aggregate soiling-loss cost for the solar panels over any multi-month future time period that starts before the recommended date.

9. The method of claim 6, further comprising:
displaying, via the GUI, the soiling loss for the solar panels that will be avoided over the multi-month future time period.

10. The method of claim 6, further comprising:
displaying, via the GUI, a post-cleaning soiling-loss forecast starting on the recommended date.

11. The method of claim 1, further comprising:
displaying, via the GUI, a calendar comprising user-selectable dates;
providing, via the GUI, a user selection of one of the user-selectable dates; and
displaying, via the GUI, a soiling loss for the solar panels that will be avoided if the cleaning occurs on the one of the user-selectable dates, in response to the user selection.

12. The method of claim 1, wherein the predicted amount of PV output that will be lost due to soiling is determined by performing a Monte Carlo simulation.

13. A method for solar-panel-soiling mitigation, the method comprising:
displaying, via a graphical user interface (GUI) on an electronic device, an estimated amount of photovoltaic (PV) output that will be lost, due to soiling of solar panels that share a site, if the solar panels are not cleaned;
displaying, via the GUI, a recommended date for cleaning the solar panels, wherein the recommended date is an earliest calendar date on which a cost of the cleaning of the solar panels is less than or equal to a cost of the estimated amount of PV output that will be lost if the solar panels are not cleaned, and wherein the earliest calendar date is determined based on a soiling loss for the solar panels that will be avoided over a multi-month future time period, starting on the recommended date, if the solar panels are cleaned on the recommended date;
displaying, via the GUI, the soiling loss for the solar panels that will be avoided over the multi-month future time period; and
displaying, via the GUI, a post-cleaning soiling-loss forecast over the multi-month future time period.

14. The method of claim 13, wherein displaying the estimated amount of PV output that will be lost if the solar panels are not cleaned comprises:
displaying, via the GUI, a 25th-percentile soiling-loss forecast over the multi-month future time period;
displaying, via the GUI, a 75th-percentile soiling-loss forecast over the multi-month future time period; and
displaying, via the GUI, a median soiling-loss forecast over the multi-month future time period, and
wherein the soiling loss for the solar panels that will be avoided comprises a difference between the post-cleaning soiling-loss forecast and the median soiling-loss forecast.

15. The method of claim 14, wherein displaying, via the GUI, the soiling loss for the solar panels that will be avoided if the solar panels are cleaned comprises:
displaying a shaded area between the post-cleaning soiling-loss forecast and the median soiling-loss forecast.

16. A method for solar-panel-soiling mitigation, the method comprising:
receiving, from solar panels that share a site, photovoltaic (PV) output data, in kilowatt-hours (kWh), for the solar panels;
determining, based on the PV output data and based on weather data, an amount of future PV output that will be lost due to soiling of the solar panels;
determining an earliest calendar date on which a cost of cleaning the solar panels is less than or equal to a cost of the amount of future PV output that will be lost due to soiling; and
transmitting, to an electronic device comprising a graphical user interface (GUI), computer-readable program code comprising the earliest calendar date.

17. The method of claim 16, further comprising:
displaying, via the GUI, the amount of future PV output that will be lost due to soiling;
displaying, via the GUI, the earliest calendar date, in response to receiving the computer-readable program code; and
transmitting, from the electronic device to a second electronic device, a work order or other electronic notification for the cleaning of the solar panels, wherein the work order or other electronic notification is based on the earliest calendar date,
wherein the second electronic device is used by an entity that performs the cleaning of the solar panels.

18. The method of claim 16,
wherein the weather data comprises rainfall data for the site, and
wherein determining the amount of future PV output that will be lost due to soiling comprises:
determining an expected PV output, in kWh, for the solar panels, based on the PV output data; and
determining, based on the rainfall data, whether an environmental cleaning event will occur for the solar panels.

19. The method of claim 16,
wherein determining the earliest calendar date comprises determining a soiling loss for the solar panels that will be avoided over a multi-month future time period following the cleaning of the solar panels, and
wherein the multi-month future time period comprises more than 60 days and no more than 90 days.

20. The method of claim 19, wherein determining the soiling loss for the solar panels that will be avoided over the multi-month future time period following the cleaning of the solar panels comprises:
determining a daily soiling loss for the solar panels over the multi-month future time period.
